(19) United States
(12) Patent Application Publication
(10) Pub. No.: US 2026/0116116 A1
(43) Pub. Date: Apr. 30, 2026

(54) PHOTO ALBUM

(71) Applicant: Tracer Imaging LLC, Ossining, NY (US)

(72) Inventors: Ryan Kelly, Queens, NY (US); Steven M. Spiro, Chappaqua, NY (US)

(73) Assignee: Tracer Imaging LLC, Ossining, NY (US)

(21) Appl. No.: 19/371,462

(22) Filed: Oct. 28, 2025

Related U.S. Application Data
(60) Provisional application No. 63/713,888, filed on Oct. 30, 2024.

(51) Int. Cl. B42F 5/02

(52) U.S. Cl. CPC B42F 5/02

(57) ABSTRACT

A photo album includes an outer cover that includes a front cover panel, a back cover panel and a spine panel extending between the front and back cover panels edge-to-edge. The photo album also includes a clip track that has a center engagement section defined by a pair of flexible opposing side walls. At least one clip that is configured to be securely engaged to the clip track. Each clip has an open position and a closed position, wherein in the open position, the clip is configured to receive one or more pages and in the closed position, the clip is configured to capture and hold the one or more pages.

### CROSS-REFERENCE TO RELATED APPLICATION

The present application claims priority to and the benefit of U.S. patent application Ser. No. 63/713,888, filed Oct. 30, 2024, which is hereby incorporated by reference in its entirety.

### TECHNICAL FIELD

The present application relates to photo albums and more particularly, to a photo album that has a book-like appearance.

### BACKGROUND

Photos are typically stored as a collection and in a safe environment that allows the photos to be not only protected but also easily viewed. For example, a photo album is a series of photographic prints collected by an individual person or family in the form of a book. There are different types of photo albums, such as albums that have compartments which the photos may be slipped into or alternatively, other albums have heavy paper covered with clear plastic sheets, on which surface photos can be put. More traditional, albums were often simply books of heavy paper on which photos could be glued to or attached to with adhesive corners or pages. A photo book can also be in form of a book in which images are printed directly onto paper and bound into a chosen book format.

### SUMMARY

In accordance with one embodiment, a photo album includes an outer cover that includes a front cover panel, a back cover panel and a spine panel extending between the front and back cover panels edge-to-edge. The photo album also includes a clip track that has a center engagement section defined by a pair of flexible opposing side walls. At least one clip that is configured to be securely engaged to the clip track. Each clip has an open position and a closed position, wherein in the open position, the clip is configured to receive one or more pages and in the closed position, the clip is configured to capture and hold the one or more pages.

A photo album includes a plurality of pages with each page having an inner edge that includes at least one elongated opening that is spaced apart and located proximate the inner edge. The photo album includes an outer cover that includes a front cover panel, a back cover panel and a spine panel extending between the front and back cover panels edge-to-edge. A clip track is coupled to the spine panel and has a center engagement section defined by a pair of flexible opposing side walls. A flexible C-shaped clip surrounds and captures the pair of flexible opposing side walls resulting in the C-shaped clip being attached to the clip track. The C-shaped clip passes through the elongated openings of the plurality of pages to capture and hold the one or more pages.

### BRIEF DESCRIPTION OF THE DRAWING FIGURES

FIG. 1 is an exploded perspective view of a photo album according to one embodiment;

FIG. 2 is a perspective view of the photo album;

FIG. 3 is an exploded perspective view of a photo album according to another embodiment;

FIG. 4 is a perspective view of the photo album;

FIG. 5 is a perspective of a photo album with two clips, in an open position and received within slots formed in a photo page;

FIG. 6 is a perspective of a photo album with two clips, in a closed position and received within slots formed in a photo page; and

FIG. 7 is a perspective of a photo album with two clips, in the closed position and received within slots formed in a photo page for reception within a clip track shown exploded therefrom.

### DETAILED DESCRIPTION OF CERTAIN EMBODIMENTS

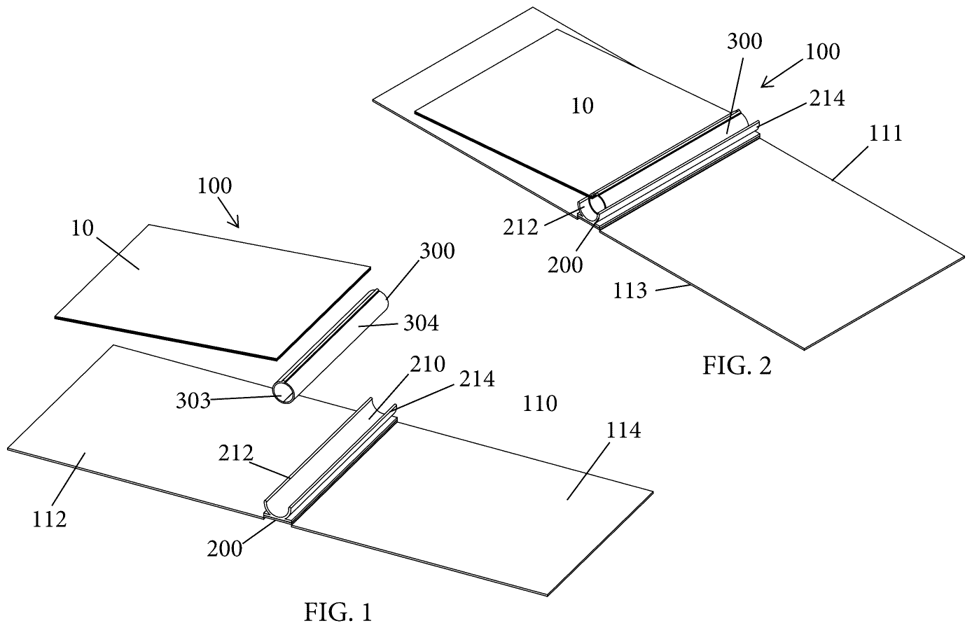

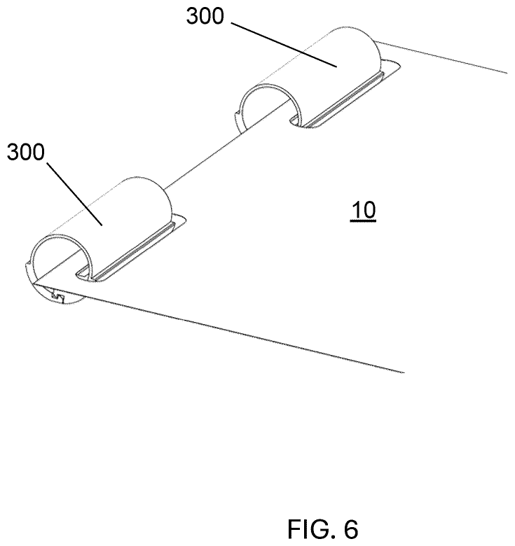

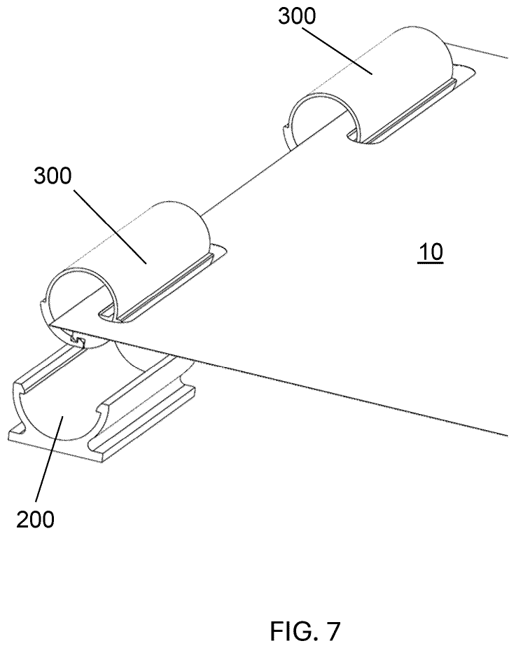

FIGS. 1-7 illustrate a photo album 100 according to two embodiments. The photo album 100 can also be thought of as being a photo book and holds a number of photo pages 10. As described herein, the photo album 100 is configured so that individual photo pages can be inserted and/are removed to allow for easy customization of the contents of the photo album 100. It will be appreciated that while the pages 10 are described herein as being photo pages, the pages 10 can contain any content, such as written text or images. In other words, the page 10 is not limited to containing one or more photos.

As shown each page 10, includes at least two openings 12 that are formed proximate one edge of the page 10. For example, each opening 12 can be in the form of an elongated slot with the two openings 12 being formed along an axis that is parallel to the one edge. Each page 10 is intended to have one or more images (photos) formed thereon. For example, a photo can be formed directly on the page 10.

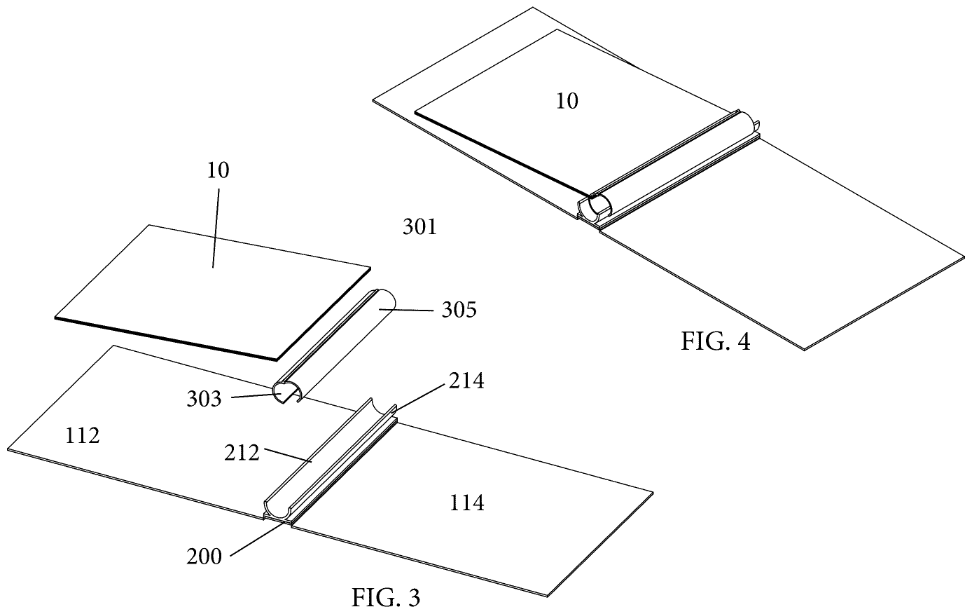

The photo album 100 includes an outer cover 110. The outer cover 110 comprises a front cover panel 112, a back cover panel 114 and a spine panel 116 extending between the front and back cover panels 112, 114 edge-to-edge. The outer cover 110 has a top edge 111 and an opposite bottom edge 113. The outer cover 110 is formed of a rigid material, such as a hard paper board material. In an alternative embodiment shown in FIGS. 1-2, the spine panel 116 can be eliminated and instead another part, described below, serves that function.

Along the inner surface (inner face) of the spine panel 116, there is a clip track 200. The clip track 200 is an elongated structure that is mounted to the inner surface between the top edge 111 and the bottom edge 113. As shown, the clip track 200 does not extend all the way to the top edge 111 and likewise does not extend all the way to the bottom edge 113. The clip track 200 can be attached to the inner surface using any number of different techniques, including the use of a bonding agent (adhesive) or fasteners, such as rivets. Alternatively, the clip track 200 can serve as the spine panel and is connected to the front panel 112 and the back panel 114.

The clip track 200 has a center engagement section 210 defined by a pair of opposing side walls 212, 214. Between the side walls 212, 214, there is a floor 216 that can have a concave shape. As described herein, the side walls 212, 214 are able to flex and more particularly, when a force is applied, the side walls 212, 214 can flex outward to permit accommodation of an object within the clip track 200 between the side walls 212, 214. Each of the side walls 212, 214 can also be curved such that the clip track 200 generally can have a C-shape. As shown, each of the side walls 212, 214 can have a lip at the top. As shown, the side walls 212, 214 and the center engagement section 210 can be a single integral molded (seamless) part.

The photo album 100 includes at least one clip 300 for detachably securing the pages 10 within the outer cover 110. The clip 300 is configured to: 1) pass through the openings (slots) 12 so as to capture the plurality of pages; and 2) detachably engage the clip track 200 to attach the pages 10 to the outer cover 110. The optional lip can serve as a locking ridge to capture and hold the clips 300 in place.

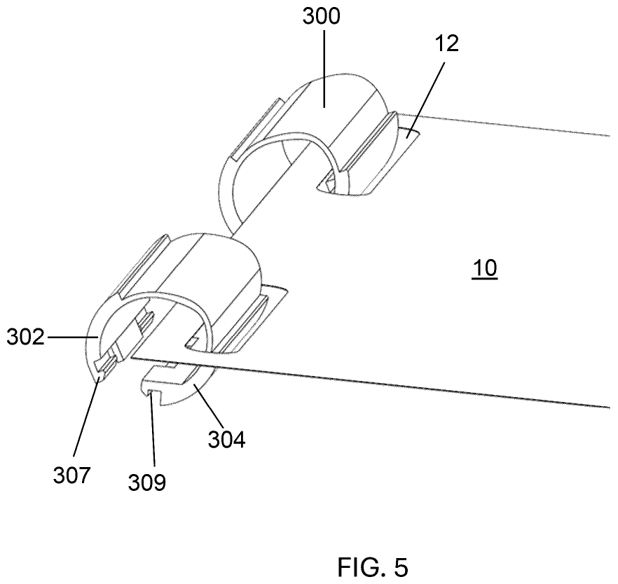

FIGS. 1-4 shows the use of a single clip 300, while FIGS. 5-7 shows the use of two clips 300.

Each clip 300 is designed to move between an open position and a closed position. In the open position, the clips 300 can receive the pages 10 with the clips 300 passing through the openings 12 and in the closed position, the clips 300 capture and hold the pages 10. Each clip 300 can be a ring clip defined by first and second arcuate sections 302, 304 and when the clip 300 is in the open position, the first and second arcuate sections 302, 304 are separated with a gap between the ends of the first and second arcuate sections 302, 304. When the clip 300 is in the closed position, the clip 300 defines a continuous ring structure, with the one edge of each page 10 being captured within the hollow interior of the clip 300. In this way, the plurality of pages 10 are all captured within the clips 300. The shapes of the openings 12 and the ring structure of the clips 300 permit the pages 10 to be turned over for viewing the pages in a series.

The first and second arcuate sections 302, 304 of the clip 300 can join one another in a snap-fit manner. For example, the free edge of the first arcuate section 302 can have a first snap-fit feature that mates with a second snap-fit feature formed along the free edge of the second arcuate section 304. For example, a detent can snap-fittingly engage a locking ridge to couple the first and second arcuate sections 302, 304. In FIG. 5, a male part 307, in the form of a locking rail, is received within a female part 309, in the form of a locking channel to couple the two sections 302, 304 to one another. The snap-fit is of a reversible type since the clips 300 must easily open to allow one or more pages 10 to be inserted or removed.

Each clip 300 can have a hinge-like construction between the first and second arcuate sections 302, 304. This accommodates the opening and closing of the first and second arcuate sections 302, 304 (like a clam shell). For example, a living hinge can be formed between the first and second arcuate sections 302, 304. Alternatively, the first and second arcuate sections 302, 304 can include a hinge member, such as a pin which joins these two sections and defines a pivot point about which the first and second arcuate sections 302, 304 open. This type of construction is like a door hinge with a pin. As mentioned, the hinge can be a weakened area of reduced thickness that defines the pivot axis.

The clip 300 has a (substantially) annular shape and is configured to snap-fitting engage the clip track 200 to thereby attach the clips 300 and the captured pages 10 to the clip track 200. The circular shapes of the clips 300 are complementary to the opening (hollow space) between the flexible side walls 212, 214. In a normal at rest position prior to insertions of the clips 300, the distance between the flexible side walls 212, 214 is less than the diameter of the clips 300 and thus, insertion of the clips 300 between the flexible side walls 212, 214 causing an outward flexing of the side walls 212, 214. The outward flexing of the side walls 212, 214 accommodates the clips 300 and facilitates a mechanical type attachment (e.g., friction fit) between the clips 300 and the clip track 200. In other words, the resilient nature of the side walls 212, 214 causes the clips 300 to be captured and securely held between the side walls 212, 214.

When the clips 300 are securely held between the side walls 212, 214, the pages 10 can be easily flipped through to allow view of the pages, no different than flipping through the pages of a book.

To release the clips 300 from the clip track 200, the flexible side walls 212, 214 are separated from one another to release the clips 300 from the clamping action of the clip track 200. Once the clips 300 are released, the captured pages 10 are removed as well. Then the clips 300 can be opened to access the pages 10.

The album 100 thus provides a product that allows for the easy creation of a book-like product in which pages 10 can easily be replaced and added.

The clip track 200 can be formed of a plastic material or other suitable material, including metal or wood, etc. In addition, the clips 300 can be formed of a plastic material.

While it is preferred to have two or more clips 300, a photo book could include one clip 300 with one center opening (center slot) formed through the pages 10. This type of construction is shown in FIGS. 1-2. The pages 10 are thus flipped about the one clip 300.

In another embodiment, the clip can engage the clip track 200 by engaging an outside of the clip track 200. This embodiment is shown in FIGS. 3-4 in which a clip 301 is shown. The clip 301 can have a C-shape that is generally defined by first and second arcuate sections 303, 305 that can pivot about a pivot axis or the clip 301 can be an integral structure and the first and second arcuate sections 303, 305 are flexible. Given the C-shape, there is an opening or gap between the first and second sections 303, 305. To attach the clip 301 to the clip track 200, the clip 301 is inverted upside down with the opening 309 facing down. The first and second arcuate sections 303, 305 of the clip 301 are flexed outward so that the side walls 212, 214 are received between the first and second arcuate sections 303, 305. In other words, the C-shaped clip 301 is spread apart and placed over the clip track 200. The resilient nature of the clip 301 causes the first and second arcuate sections 303, 305 to grasp the side walls 212, 214 since the first and second arcuate sections 303, 305 want to return to its natural at rest position (a position that the distance between the first and second arcuate sections 303, 305 is less than the distance when the clip 301 is over the clip track 200).

When the C-shaped clip 301 is in this inverted position, the pages 10 can freely be flipped to allow viewing of all of the pages.

It will thus be seen from the various embodiments that the clip(s) that holds the pages 100 can be one clip or can be a plurality of clips and the clip(s) can be held between the side walls 212, 214 or they can be disposed outside of the clip track (outside of the side walls 212, 214). Either way, the clip and clip track engage one another in a friction fit with either the clip inside of the clip track or alternatively, the clip can lie outside the clip track.

In each of the embodiments, the pages are captured by one or more clips. The one or more clips have an arcuate shape to allow for the flipping of the pages. Once all of the pages are captured by the clip, the clip then engages the clip track, whereby the clip and clip track are in a friction fit that is detachable to allow for the detachment of the clip(s) to permit insertion and/or removal of the pages.

It is to be understood that like numerals in the drawings represent like elements through the several figures, and that not all components and/or steps described and illustrated with reference to the figures are required for all embodiments or arrangements.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not precludes the presence or addition of one or more other features, integers, steps, operations, elements, components, and/or groups thereof.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

The subject matter described above is provided by way of illustration only and should not be construed as limiting. Various modifications and changes can be made to the subject matter described herein without following the example embodiments and applications illustrated and described, and without departing from the true spirit and scope of the present invention, which is set forth in the following claims.

What is claimed is:

1. A photo album comprising:
an outer cover that includes a front cover panel, a back cover panel and a spine panel extending between the front and back cover panels edge-to-edge;
a clip track that has a center engagement section defined by a pair of flexible opposing side walls; and
at least one clip that is configured to be securely engaged to the clip track, each clip having an open position and a closed position, wherein in the open position, the clip is configured to receive one or more pages and in the closed position, the clip is configured to capture and hold the one or more pages.

2. The photo album of claim 1, wherein the at least one clip comprises a plurality of clips.

3. The photo album of claim 1, wherein the least one clip is configured to be securely captured within the clip track between the pair of flexible opposing side walls.

4. The photo album of claim 1, wherein the at least one clip is disposed along outer surfaces of the pair of flexible opposing side walls.

5. The photo album of claim 1, wherein the clip track is located along an inner surface of the spine panel.

6. The photo album of claim 1, wherein each of the pair of flexible opposing side walls has an inwardly curved shape.

7. The photo album of claim 2, wherein the clip has a diameter that is greater than a minimum distance between the pair of flexible opposing side walls.

8. The photo album of claim 1, wherein the clip track is formed of plastic.

9. The photo album of claim 1, wherein the outer cover is formed of paper board.

10. The photo album of claim 1, wherein each of the flexible opposing side walls has a top lip.

11. The photo album of claim 1, wherein the clip track has a C-shape.

12. The photo album of claim 1, wherein each clip has an annular shape.

13. The photo album of claim 1, wherein each clip has a C-shape.

14. The photo album of claim 1, wherein each clip is defined by a first arcuate section and a second arcuate section connected to the first arcuate section by a hinge that allows the clip to move between the open and closed positions.

15. The photo album of claim 14, wherein a top edge of the first arcuate section has a locking ridge and the top edge of the second arcuate section has a locking detent that engages the locking ridge to snap-fittingly attach the first arcuate section to the second arcuate section.

16. A photo album comprising:
a plurality of pages, each page has an inner edge that includes a plurality of elongated openings that are spaced apart and located proximate the inner edge;
an outer cover that includes a front cover panel, a back cover panel and a spine panel extending between the front and back cover panels edge-to-edge;
a clip track that has a center engagement section defined by a pair of flexible opposing side walls; and
a plurality of clips that are configured to be securely captured within the clip track between the pair of flexible opposing side walls, each clip having an open position and a closed position, wherein in the open position, the clips pass through the elongated openings of one or more pages and in the closed position, the clips are configured to capture and hold the one or more pages.

17. A photo album comprising:
a plurality of pages, each page has an inner edge that includes at least one elongated opening that is spaced apart and located proximate the inner edge;
an outer cover that includes a front cover panel, a back cover panel and a spine panel extending between the front and back cover panels edge-to-edge;
a clip track that is coupled to the spine panel and has a center engagement section defined by a pair of flexible opposing side walls; and
a flexible C-shaped clip that surrounds and captures the pair of flexible opposing side walls resulting in the C-shaped clip being attached to the clip track, the C-shaped clip passes through the elongated openings of the plurality of pages to capture and hold the one or more pages.
